(19) United States
(12) Patent Application Publication
(10) Pub. No.: US 2021/0319392 A1
(43) Pub. Date: Oct. 14, 2021

(54) PRODUCT RE-ORDERING NOTIFICATION DEVICE

(71) Applicant: Pravin Chhatrapati PATIL, Maharashtra (IN)

(72) Inventor: Pravin Chhatrapati PATIL, Thane, Maharashtra (IN)

(21) Appl. No.: 17/271,752

(22) PCT Filed: Nov. 5, 2018
(86) PCT No.: PCT/IB2018/058650

§ 371 Date: Feb. 26, 2021

(30) Foreign Application Priority Data
Aug. 27, 2018 (IN) 201821032072

(51) Int. Cl. G06Q 10/08; G06Q 50/28; G06Q 30/06; G06Q 20/32

(52) U.S. Cl. CPC G06Q 10/087; G06Q 20/3276; G06Q 30/0633; G06Q 50/28

(57) ABSTRACT

The present disclosure relates to a product re-ordering notification device that comprises a scanner, and a slot to receive a tag, wherein the tag has a unique scannable code printed on its first side, said code being mapped to a product such that when the tag is inserted in the slot, said scanner scans the tag so as to generate and transmit, to a first computing device, a first signal based on which reordering of the product is performed by user of said first computing device.

### FIELD OF THE INVENTION

The present disclosure pertains to a product re-ordering notification device and a method of operation thereof.

### BACKGROUND

The following description includes information that may be useful in understanding the present invention. It is not an admission that any of the information provided herein is prior art or relevant to the presently claimed invention, or that any publication specifically or implicitly referenced is prior art.

Ordering of food products automatically based on their consumption pattern has been talked about in a few literatures, but none of them really makes the complete ordering process seamless, wherein few of such publications either try to make identification of when to re-order easy, but complicate the actual ordering process, or the visa-versa.

There is therefore a need in the art for a new solution that can make the product/item re-ordering easy and seamless.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY

The present disclosure pertains to a product re-ordering notification device and a method of operation thereof.

The present disclosure relates to a product re-ordering notification device comprising: a scanner; and a slot to receive a tag, wherein the tag has a unique scannable code printed on its first side, said code being mapped to a product such that when the tag is inserted in the slot, said scanner scans the tag so as to generate and transmit, to a first computing device, a first signal based on which reordering of the product is performed by user of said first computing device.

In an aspect, the tag comprises a second side on which a graphical representation of the product is positioned.

In another aspect, the tag can be operatively coupled with a product container by means of a tag holder, wherein when the product in said container is below a certain level, said tag is detached by a second user from said container, and inserted into the slot of said device for transmission of said first signal. In an exemplary embodiment, the tag holder can stick the tag onto a surface of the container.

In an aspect, the reordering can be performed automatically by the first computing device.

In another aspect, the unique scannable code can be a barcode and the scanner can be a barcode scanner.

In another aspect, the device can include a scanner switch that can be configured such that when the tag is inserted in the slot, said switch is rendered ON so as to activate the scanner.

In an aspect, the device can further include a chip holder which when actuated, enables to eject at least one tag that is stored in the chip holder through said slot, said scanner disables the scanning of said at least one tag while ejection. In another aspect, the chip holder can be operatively coupled with a chip eject switch, which when actuated, ejects at least one tag that is stored in the chip holder.

In an aspect, the first signal can be transmitted wirelessly to the first computing device through a cellular connection. In another aspect, the device can further include any or a combination of a charging slot, a display, and a camera unit.

In an aspect, the present disclosure relates to a tag that can have a first side on which a unique scannable code is printed, and a second side on which graphical representation of a product is positioned, wherein the unique scannable code can be mapped to the product and associated with a container that holds the product such that the tag is receivable in a slot of a device that comprises a scanner to scan the tag when received, and generates and transmits, to a first computing device, a first signal based on which reordering of the product is performed by user of said first computing device.

### BRIEF DESCRIPTION OF DRAWINGS

FIG. 1 illustrates an exemplary representation of the proposed product re-ordering notification device in accordance with an embodiment of the present invention.

FIG. 2 illustrates exemplary representations of the proposed product container tag in accordance with an embodiment of the present invention.

FIG. 3 illustrates another exemplary architectural environment that comprises one or more product re-ordering notification device in accordance with an embodiment of the present invention.

FIG. 4 illustrates an exemplary implementation use case of the proposed product re-ordering notification device in accordance with an embodiment of the present invention.

FIG. 5 illustrates an exemplary flow diagram illustrating working of the proposed system with in accordance with an embodiment of the present invention.

### DETAILED DESCRIPTION OF DRAWINGS

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Arrangements and embodiments may now be described more fully with reference to the accompanying drawings, in which exemplary embodiments may be shown. Embodiments may, however, be embodied in many different forms and should not be construed as being limited to embodiments set forth herein; rather, embodiments may be provided so that this disclosure will be thorough and complete, and will fully convey the concept to those skilled in the art.

The suffixes ‘module’, ‘unit’ and ‘part’ may be used for elements in order to facilitate the disclosure. Significant meanings or roles may not be given to the suffixes themselves and it is understood that the ‘module’, ‘unit’ and ‘part’ may be used together or interchangeably.

The present disclosure pertains to a product re-ordering notification device and a method of operation thereof.

The present disclosure relates to a product re-ordering notification device comprising: a scanner; and a slot to receive a tag, wherein the tag has a unique scannable code printed on its first side, said code being mapped to a product such that when the tag is inserted in the slot, said scanner scans the tag so as to generate and transmit, to a first computing device, a first signal based on which reordering of the product is performed by user of said first computing device.

In an aspect, the tag comprises a second side on which a graphical representation of the product is positioned.

In another aspect, the tag can be operatively coupled with a product container by means of a tag holder, wherein when the product in said container is below a certain level, said tag is detached by a second user from said container, and inserted into the slot of said device for transmission of said first signal. In an exemplary embodiment, the tag holder can stick the tag onto a surface of the container.

In an aspect, the reordering can be performed automatically by the first computing device.

In another aspect, the unique scannable code can be a barcode and the scanner can be a barcode scanner.

In another aspect, the device can include a scanner switch that can be configured such that when the tag is inserted in the slot, said switch is rendered ON so as to activate the scanner.

In an aspect, the device can further include a chip holder which when actuated, enables to eject at least one tag that is stored in the chip holder through said slot, said scanner disables the scanning of said at least one tag while ejection. In another aspect, the chip holder can be operatively coupled with a chip eject switch, which when actuated, ejects at least one tag that is stored in the chip holder.

In an aspect, the first signal can be transmitted wirelessly to the first computing device through a cellular connection. As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems, millimeter wave or microwave systems, optical, acoustic, and infrared (i.e., IrDA). In another aspect, the device can further include any or a combination of a charging slot, a display, and a camera unit.

In an exemplary aspect, the cellular connection can be a network. In one implementation, the network may be a wireless network, a wired network or a combination thereof. The network can be implemented as one of the different types of networks, such as intranet, local area network (LAN), wide area network (WAN), the interne, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In an aspect, the present disclosure relates to a tag that can have a first side on which a unique scannable code is printed, and a second side on which graphical representation of a product is positioned, wherein the unique scannable code can be mapped to the product and associated with a container that holds the product such that the tag is receivable in a slot of a device that comprises a scanner to scan the tag when received, and generates and transmits, to a first computing device, a first signal based on which reordering of the product is performed by user of said first computing device.

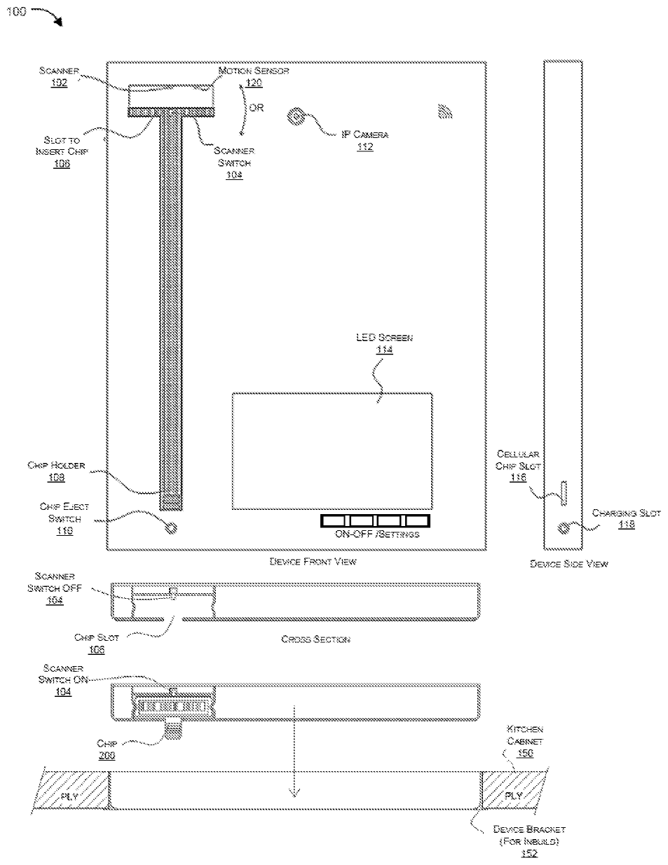

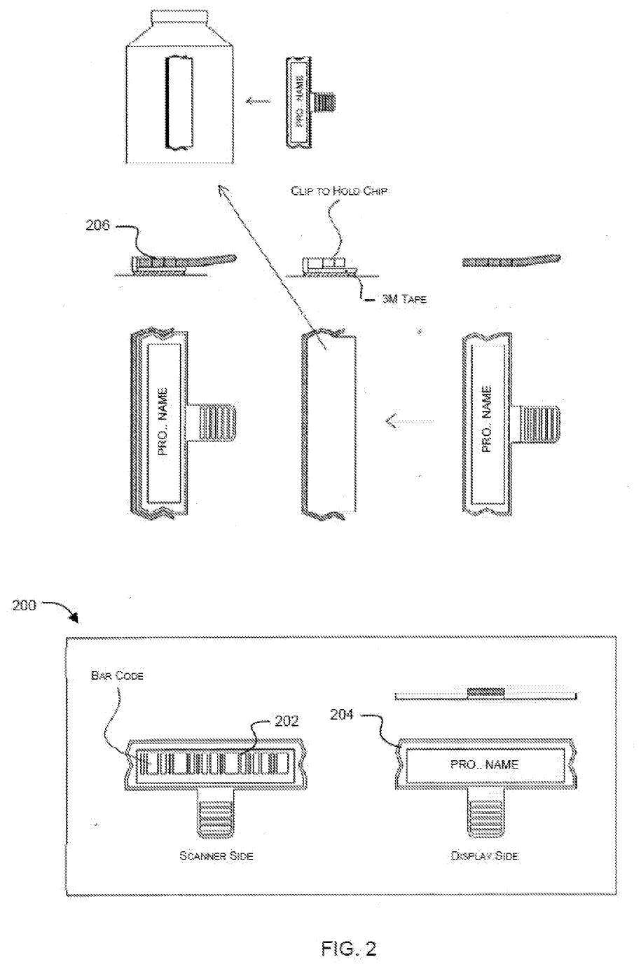

FIGS. 1 and 2 illustrate exemplary representations 100 and 200 of the proposed product re-ordering notification device in accordance with an embodiment of the present invention. In an aspect, the proposed product re-ordering notification device can include a scanner 102 (such as a barcode scanner 102) that is configured to read a tag 200 (also interchangeably referred to chip hereinafter) that is inserted into a slot 106.

In an aspect, the tag 200 can be of any form factor and therefore there is no limitation thereto as regards the present invention is concerned. Tag 200 can, in an exemplary implementation, include two sides, a first side (referred to as the scanner side) 202 on which a unique identification code such as a barcode is printed, and a second side 204 on which name of a product (such as a food item like rice, flour, sugar, etc.) can written or depicted in any graphical representation/form, all of which possibilities are well within the scope of the present invention.

In an aspect, the tag 200 can be associated/attached/coupled with a product container, say a jar containing rice or sugar, with the tag 200 having one side written with the product name/photo and the other side with a unique identification code that is uniquely mapped with that product. The tag 200 can be operatively/detachably coupled with a tag handle such as a clip 206 that can help fix/couple the tag 200 onto/with the container containing the product.

In an implementation, when the amount of product such as food item stored in the container goes below a defined range/level, a person such as a servant can detach/de-couple the tag 200 from the container, and place/insert the same into the chip slot 106.

In an exemplary implementation, the proposed device 100 can include a scanner switch 104 which can be activated when the tag/chip 200 is inserted into the slot 106 as can be seen in FIG. 1, wherein the scanner switch 104 is OFF by default, and when the tag 200 is inserted, the switch 104 is pressed and accordingly put in ON condition so as to activate the scanner and scan the barcode/unique identification code 202 side of the tag 200. Upon reading of the tag code, the scanner can understand the product that requires re-ordering and can accordingly generate/transmit a first signal/packet/instruction to a first computing device such as mobile phone of a user/owner of the product/container so that the user/owner can then re-order the product at a desired volume through one or more mobile applications/portals, for instance.

In an aspect, the product re-ordering can be performed through any means including but not limited to, through online shopping applications or even offline shopping by physically going to the grocery store, for instance, or through a combination of the same. Also, although the present invention has been explained with re-ordering of food products/items/articles, the invention is of course not limited to the same and includes any kind of product in its scope.

In another aspect, instead of a scanner switch 104 to detect when the tag is inserted, the present invention can allow any other means of detecting insertion of the tag/chip into the slot, for instance, a motion sensor 120 that can be configured to sense when the tag is received into the slot, based on which the scanner can be actuated to scan the tag and identify the product corresponding to the tag.

In an exemplary embodiment, the proposed device can send the notification/signal for re-ordering of the product through any or a combination of a Bluetooth, Wireless, Wi-Fi, Zigbee connection, all of which and other known techniques for communicating such notifications are well within the scope of the present invention.

In another aspect, the proposed device 100 can optionally include a camera 112 (such as an IP Camera), a display 114 (such as an LED screen), a cellular chip slot 116 (for establishing cellular connection between the device 100 and the mobile phone/first computing device of the owner/user), and a charging slot 118 for charging the device.

In another exemplary aspect, when the tag/chip is inserted into the slot, and after the scanning operation has been completed by the scanner 102, the tag/chip can drop into a chip holder 108, which can collect the tags that have been scanned. Such collected tags can also be reused by taking them out of the chip holder 108 through, for instance, a chip eject switch 110. As would be appreciated, these are only exemplary implementation, and any other system/mechanism that enables aspects of the present invention to be implemented/complied are well within the scope of the present invention.

In an aspect, the proposed device can be received to a kitchen cabinet 150 by means of a device bracket 152. Any other means of fixing or positioning the proposed product-reordering device is well within the scope of the present invention.

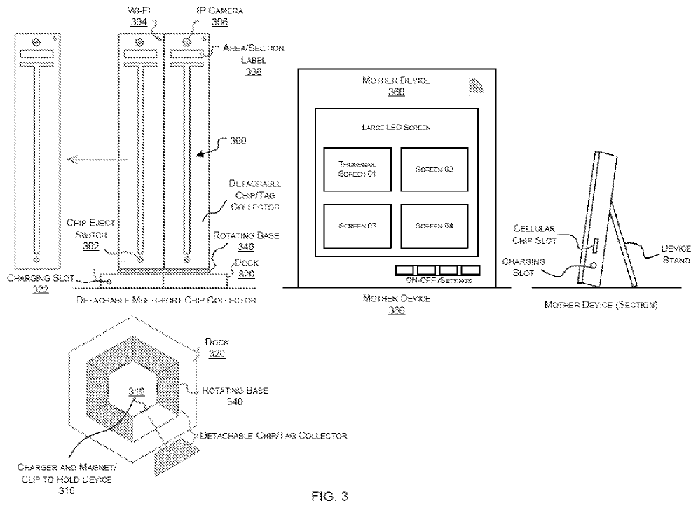

FIG. 3 illustrates another exemplary architectural environment that comprises one or more product re-ordering notification devices in accordance with an embodiment of the present invention. As can be seen, the embodiment can include a detachable multi-port chip/tag collector 300 having a dock 320 configured to hold/position one or more product re-ordering notification devices collector devices 300 so that multiple tags can be used at a given time for being scanned and product reordering signal to be generated. The dock 320 can optionally include a charging slot 322, wherein, on the dock 320, a rotating base 340 is configured, and wherein, one or more multi-port chip/tag collectors 300 are positioned on the rotating base 340.

As can be seen, the detachable collector device 300 can include, but is not limited to, a chip ejection switch 302 to eject one or more collected tags/chips, a Wi-Fi device/component 304, and an IP camera 306. The device 300 can further include an area earmarked as 308 that can be used for receiving a label indicating the section/department in which the device is being used.

The collector 300 can further include one or more clips/holders/magnets 310 to hold respective collector devices 300 onto the rotating base 340. In an aspect, a charging slot can also be provided such that when the collector device 300 is on the base 340, it is charged.

In an aspect, one or more collector devices can be operatively coupled to a mother device 360 that can control the operation function of the coupled/connected one or more collector devices. The mother device 360 can be a central server or even a client device such as mobile phone or a laptop or a desktop PC or any other computing device that can include, for instance, one or more screens/displays to control operation of each chip collector 300 and/or each notification device 100 that forms part of respective controller.

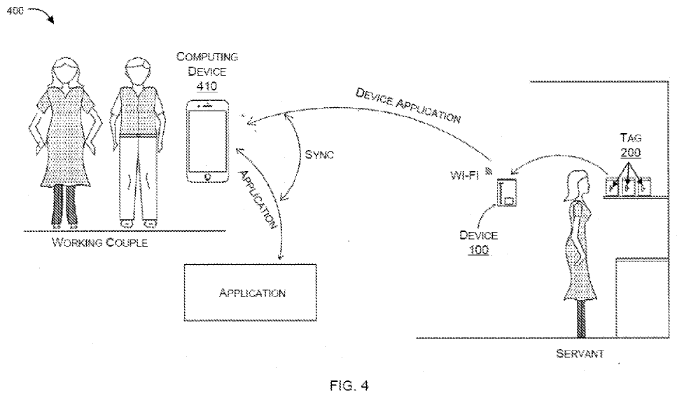

FIG. 4 illustrates an exemplary implementation use case 400 of the proposed product re-ordering notification device in accordance with an embodiment of the present invention. As can be seen, a servant can notice that the level of a product in a container, say of rice in a container is less than the desired amount (based on a rough estimate for instance), and can then detach the tag/chip that is associated/fixed onto/with the container, and insert the tag in the slot of the notification device 100 so as to enable the scanner that is configured in the device to scan the tag, and understand the product (rice in this instance) that the tag corresponds to, and then transmit a notification to the owner/working couple through a mobile application, for instance, or through any other means such as a SMS, WhatsApp, multimedia message, missed call, or any other desired notification type. Upon receiving the notification, the owner/couple can, through one or more known applications/platforms/portals, order the product to replenish the container accordingly.

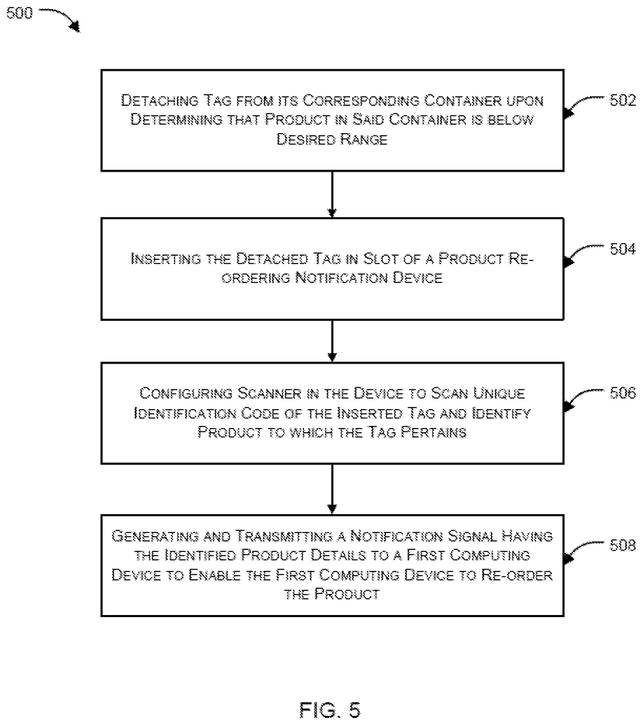

FIG. 5 illustrates an exemplary flow diagram illustrating working of the proposed system with in accordance with an embodiment of the present invention. As can be seen, at step 502, upon determining that the level of a product in its container is below a defined range, a user detaches tag associated with the container, and at step 504, inserts the tag into the slot of proposed notification device. At step 506, scanner configured in the device can scan the unique code printed on the tag, and determine the product to which the tag corresponds, based on which at step 508, a notification signal can be generated and transmitted by the notification device to a first computing device such as mobile phone, based on which user of the first computing device can re-order the product.

As used herein, and unless the context dictates otherwise, the term “coupled to” is intended to include both direct coupling; in which two elements that are coupled to each other contact each other, and indirect coupling; in which at least one additional element is located between the two elements. Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

I claim:

1. A product re-ordering notification device comprising:
a scanner; and
a slot to receive a tag, wherein the tag has a unique scannable code printed on its first side, said code being mapped to a product such that when the tag is inserted in the slot, said scanner scans the tag so as to generate and transmit, to a first computing device, a first signal based on which reordering of the product is performed by user of said first computing device.

2. The device as claimed in claim 1, wherein the tag comprises a second side on which a graphical representation of the product is positioned.

3. The device as claimed in claim 1, wherein the tag is operatively coupled with a product container by means of a tag holder, wherein when the product in said container is below a certain level, said tag is detached by a second user from said container, and inserted into the slot of said device for transmission of said first signal.

4. The device as claimed in claim 3, wherein said tag holder sticks said tag onto a surface of said container.

5. The device as claimed in claim 1, wherein said reordering is performed automatically by said first computing device.

6. The device as claimed in claim 1, wherein the unique scannable code is a barcode and said scanner is a barcode scanner.

7. The device as claimed in claim 1, wherein the device comprises a scanner switch which is configured such that when the tag is inserted in the slot, said switch is rendered ON so as to activate the scanner.

8. The device as claimed in claim 1, wherein the device further comprises a chip holder that receives the tag after the scanning operation on the tag is complete.

9. The device as claimed in claim 8, wherein the chip holder is operatively coupled with a chip eject switch, which when actuated, enables to eject at least one tag that is stored in the chip holder through said slot, said scanner disables the scanning of said at least one tag while ejection.

10. The device as claimed in claim 1, wherein the first signal is transmitted wirelessly to the first computing device through a cellular connection.

11. The device as claimed in claim 1, wherein the device further comprises any or a combination of a charging slot, a display, and a camera unit.

12. A tag comprising a first side on which a unique scannable code is printed, and a second side on which graphical representation of a product is positioned, wherein the unique scannable code is mapped to the product and associated with a container that holds said product such that said tag is receivable in a slot of a device that comprises a scanner to scan the tag when received and generates and transmits, to a first computing device, a first signal based on which reordering of the product is performed by user of said first computing device.
